(19) United States
(12) Patent Application Publication
(10) Pub. No.: US 2023/0134743 A1
(43) Pub. Date: May 4, 2023

(54) FREQUENCY DOMAIN RESOURCE CONFIGURATION IN IAB

(71) Applicant: TELEFONAKTIEBOLAGET LM ERICSSON (PUBL), STOCKHOLM (SE)

(72) Inventors: Magnus Åström, LUND (SE); Erik Dahlman, STOCKHOLM (SE); Boris Dortschy, VENDELSÖ (SE); Lei Bao, GÖTEBORG (SE); Behrooz Makki, PIXBO (SE)

(21) Appl. No.: 17/917,521

(22) PCT Filed: Apr. 6, 2021
(86) PCT No.: PCT/IB2021/052852

§ 371 Date: Oct. 6, 2022

Related U.S. Application Data
(60) Provisional application No. 63/006,002, filed on Apr. 6, 2020.

(51) Int. Cl. H04L 5/00

(52) U.S. Cl. CPC H04L 5/0035

(57) ABSTRACT

Systems and methods are disclosed herein for frequency domain resource configuration in an Integrated Access and Backhaul (IAB) node. In one embodiment, a method performed by an IAB node configured to operate in a spectrum band comprises receiving a configuration message(s) related to the spectrum band comprising information that defines two or more modes of operation of a distributed unit (DU) of the IAB node that are allowed for two or more subsets of a plurality of subcarriers within the spectrum band of the IAB node, respectively. The method further comprises allocating at least one of the subsets of the plurality of subcarriers within the spectrum band for performing an operation based on a mode of operation of the IAB node and the information comprised in the configuration message(s) and performing the operation on the allocated at least one of the subsets of the plurality of subcarriers.

### RELATED APPLICATIONS

This application claims the benefit of U.S. Provisional Patent Application No. 63/006,002, filed Apr. 6, 2020, the disclosure of which is hereby incorporated herein by reference in its entirety.

### TECHNICAL FIELD

The present disclosure relates to an Integrated Access and Backhaul (IAB) deployment of a radio access network (RAN) in a cellular communication system.

### BACKGROUND

In Third Generation Partnership Project (3GPP) Rel-16, there is an ongoing Work Item (WI) for Integrated Access Backhaul (IAB) based on earlier study item documented in 3GPP Technical Report (TR) 38.874 V16.0.0. The purpose of IAB is to replace existing wired backhaul or a wireless backhaul with flexible wireless backhaul using the existing 3GPP bands providing not only backhaul but also existing cellular services in the same node. This, in addition to creating more flexibility, is generally to reduce the cost for a wired backhaul, which in certain deployments could impose a large cost for the installation and operation of the base station (BS).

The Donor node (e.g., donor IAB node) is the only node connected to a wired backhaul, each IAB node in the chain of nodes acts as child node towards upstream IAB nodes and parent towards downstream IAB nodes. Each IAB node holds a distributed unit (DU) function and a Mobile Termination (MT) function as shown in reference architecture in FIG. 1 (also depicted in 6.3.1-1 in 3GPP TR 38.874). The DU is also referred to herein as an “IAB-DU”, and the MT is also referred to herein as an “IAB-MT”. Via the MT, the IAB node connects to an upstream IAB node or the IAB donor. Via the DU, the IAB node establishes Radio Link Control (RLC) channels to MTs of downstream IAB nodes or provides access links to User Equipments (UEs). FIG. 1 conceptually shows the possible connections for an IAB node, including access link to UEs and backhaul links to both an upstream parent IAB node and a downstream child IAB node.

The IAB-MT may transmit or receive using time-frequency resources that would otherwise be possible to allocate for UE transmit and receive operations to and from a base station (BS). Hence, introducing the IAB node will incur overhead into the system in that additional transmit and receive operations will be necessary. In Rel-16, the multiplexing of MT and DU operations were performed in the time domain, i.e., different symbols have different utilization.

In order to manage the different combinations of transmission and reception in the MT and the DU parts of the IAB node, the DU is constrained according to the following excerpt from R1-2001452, CR on TS38.213, “Corrections on integrated access and backhaul”, 3GPP TSG-RAN WG1 Meeting #100-e, Feb. 24-Mar. 6, 2020:
With reference to slots of an IAB-node DU serving cell, a symbol in a slot of an IAB-node DU serving cell can be configured to be of hard, soft, or unavailable type. When a downlink, uplink, or flexible symbol is configured as hard, the IAB-node DU serving cell can respectively transmit, receive, or either transmit or receive in the symbol.
When a downlink, uplink, or flexible symbol is configured as soft, the IAB-node DU can respectively transmit, receive or either transmit or receive in the symbol only if
   the IAB-node MT does not transmit or receive in the symbol, or
   the IAB-node MT would transmit or receive in the symbol, and the transmission or reception in the symbol is not changed due to a use of the symbol by the IAB-node DU, or
   the IAB-node MT detects a DCI format 2_5 with an AI index field value indicating the soft symbol as available
When a symbol is configured as unavailable, the IAB-node DU neither transmits nor receives in the symbol.

Rel-16 focused on time multiplexing of different combinations of uplink (UL) and downlink (DL) operation in the MT and DU, respectively, see FIG. 2 as an example. FIG. 2 illustrates an example of time multiplexed DU slot configuration (hard, soft, or unavailable) in relation to a given DU slot format (uplink or downlink)

One of the objectives in the Rel-17 IAB WID RP-193251 is to specify an enhanced multiplexing, as presented in the following excerpt from RP-193251:
Specification of enhancements to the resource multiplexing between child and parent links of an IAB node, including:
   Support of simultaneous operation (transmission and/or reception) of IAB-node's child and parent links (i.e., MT Tx/DU Tx, MT Tx/DU Rx, MT Rx/DU Tx, MT Rx/DU Rx).
      Simultaneous operation
   Support for dual-connectivity scenarios defined by RAN2/RAN3 in the context of topology redundancy for improved robustness and load balancing.
      Multiple parent/child nodes

### SUMMARY

Systems and methods are disclosed herein for frequency domain resource configuration in an Integrated Access and Backhaul (IAB) node. In one embodiment, a method performed by an IAB node operating in a spectrum band comprises receiving one or more configuration messages related to the spectrum band, the one or more configuration messages comprising information that defines two or more modes of operation of a distributed unit (DU) of the IAB node that are allowed for two or more subsets of a plurality of subcarriers within the spectrum band of the IAB node, respectively. The method further comprises, based on a mode of operation of the IAB node and the information comprised in the configuration message(s), allocating at least one of the two or more subsets of the plurality of subcarriers within the spectrum band for performing an operation. The method further comprises performing the operation on the allocated at least one of the two or more subsets of the plurality of subcarriers. In this manner, efficient frequency multiplexing of mobile termination (MT) and DU operation regarding transmission and reception functionality can be provided. This introduces greater scheduling flexibility in the network and allows for reduced latency communications and improved cross-link interference mitigation in that different IAB nodes have more degrees of freedom for scheduling.

In one embodiment, the two or more subsets of the plurality of subcarriers within the spectrum band of the IAB node are mutually exclusive.

In one embodiment, the two or more modes of operation comprise two or more of the following modes of operation: a first mode of operation in which DU transmission, DU reception, or either DU transmission or DU reception may be performed by the IAB node; a second mode of operation in which DU transmission, DU reception, or either DU transmission or DU reception may be performed by the IAB node, subject to a condition; and a third mode of operation in which neither DU transmission nor DU reception may be performed by the IAB node. In one embodiment, the two or more modes of operation comprise the second mode of operation, and the condition depends on: (a) whether the subset of the subcarriers configured for the second mode of operation are configured as unavailable for the DU of the parent IAB node or not used on a mobile termination (MT) side of the IAB node, (b) whether the IAB node has received a control message that indicates that the subset of the subcarriers configured for the second mode of operation are available for transmission or reception, (c) whether operation on the MT side of the IAB is not impacted, and (d) a combination of two or more of (a)-(c). In one embodiment, the operation performed by the IAB node depends on a symbol configuration of symbol in which the operation is to be performed within in a slot. In one embodiment, the symbol configuration is one of: a configuration of the symbol as an uplink symbol in which case the operation is reception by the DU of the IAB; a configuration of the symbol as a downlink symbol in which case the operation is transmission by the DU of the IAB node; or a configuration of the symbol as a flexible symbol in which case the operation is reception or transmission by the DU of the IAB node. In one embodiment, the operation performed by the IAB node is: transmitting by the DU of the IAB node, if the symbol in which the operation is to be performed is a downlink symbol and the mode of operation is either (a) the first mode of operation or (b) the second mode of operation provided the condition is met; receiving by the DU of the IAB node, if the symbol in which the operation is to be performed is an uplink symbol and the mode of operation is either (a) the first mode of operation or (b) the second mode of operation provided the condition is met; transmitting or receiving by the DU of the IAB node, if the symbol in which the operation is to be performed is a flexible symbol and the mode of operation is either (a) the first mode of operation or (b) the second mode of operation provided the condition is met; or neither transmitting nor receiving by the DU of the IAB node, if the mode of operation is the third mode of operation. In one embodiment, the operation performed by the IAB node further involves control signaling to schedule a User Equipment (UE) and/or a child IAB node to transmit or receive in a certain time-frequency resource according to the configurations of a symbol(s) in which the operation is to be performed by the IAB node and the allocated at least one of the two or more subsets of the plurality of subcarriers.

In one embodiment, the method further comprises, prior to receiving the one or more configuration messages, transmitting a capability message to a parent IAB node. In one embodiment, the capability message comprises information that indicates that the IAB node has digital beamforming capability for Spatial Division Multiplexing (SDM). In one embodiment, the capability message comprises information that indicates that the IAB node has a capability to partition the frequency spectrum according to the two or more modes of operation.

Corresponding embodiments of an IAB node are also disclosed. In one embodiment, an IAB node for operating in a spectrum band is adapted to receive one or more configuration messages related to the spectrum band, the one or more configuration messages comprising information that defines two or more modes of operation of a DU of the IAB node that are allowed for two or more subsets of a plurality of subcarriers within the spectrum band of the IAB node, respectively. The IAB node is further adapted to, based on a mode of operation of the IAB node and the information comprised in the configuration message(s), allocate at least one of the two or more subsets of the plurality of subcarriers within the spectrum band for performing an operation. In one embodiment, the IAB node is further adapted to perform the operation on the allocated at least one of the two or more subsets of the plurality of subcarriers.

In one embodiment, an IAB node for operating in a spectrum band comprising processing circuitry configured to cause the IAB node to receive one or more configuration messages related to the spectrum band, the one or more configuration messages comprising information that defines two or more modes of operation of a DU of the IAB node that are allowed for two or more subsets of a plurality of subcarriers within the spectrum band of the IAB node, respectively. The processing circuitry is further configured to cause the IAB node to, based on a mode of operation of the IAB node and the information comprised in the configuration message(s), allocate at least one of the two or more subsets of the plurality of subcarriers within the spectrum band for performing an operation. In one embodiment, the processing circuitry is further configured to cause the IAB node to perform the operation on the allocated at least one of the two or more subsets of the plurality of subcarriers.

In one embodiment, a method performed by an IAB node configured to operate in a spectrum band comprises identifying a parent IAB node of the IAB node and sending a message to the parent IAB node that comprises information that the IAB node has a capability to partition the frequency spectrum according to the two or more modes of operation. The method further comprises receiving one or more configuration messages related to the spectrum band from the parent IAB node and configuring a DU of the IAB node based on the one or more configuration messages.

In one embodiment, the one or more configuration messages comprise information that defines two or more modes of operation of the DU of the IAB node that are allowed for two or more subsets of a plurality of subcarriers within the spectrum band of the IAB node, respectively.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an Integrated Access and Backhaul (IAB) architecture;

FIG. 2 illustrates an example of time multiplexed Distributed Unit (DU) slot configuration (hard, soft, or unavailable) in relation to a given DU slot format (uplink or downlink);

FIG. 3 illustrates one example of a radio access network (RAN) having a IAB architecture in which embodiments of the present disclosure may be implemented;

FIG. 4 is a flow chart that illustrates the operation of a IAB node in accordance with embodiments of the present disclosure;

FIG. 5 illustrates an example of a frequency multiplexed DU slot configuration in relation to a given DU slot format in accordance with an embodiment of the present disclosure;

FIG. 6 is a flow chart that illustrates the operation of a IAB node in accordance with another embodiment of the present disclosure;

FIGS. 7 and 8 are schematic block diagrams of example embodiments of an IAB node;

FIG. 9 illustrates an example embodiment of a communication system in which embodiments of the present disclosure may be implemented;

FIG. 10 illustrates example embodiments of the host computer, base station, and a User Equipment (UE) of FIG. 9; and

FIGS. 11, 12, 13, and 14 are flow charts that illustrate example embodiments of methods implemented in a communication system such as that of FIG. 9.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

IAB Node: As used herein, an Integrated Access and Backhaul (IAB) node is a RAN node that supports wireless access to UEs and wirelessly backhauls the access traffic.

IAB Donor Node: As used herein, an IAB donor node is a node that connects to the core network (e.g., via wired connection such as, e.g., a fiber connection). The IAB donor includes a Central Unit (CU). Note that an IAB donor node may also be an IAB node. For instance, a donor IAB node is a parent IAB node.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). The existing IAB solution does not allow for frequency multiplexing between the IAB Mobile Termination (MT)/IAB Distributed Unit (DU) transmit and receive operations of shared frequency resources. Frequency multiplexing may be advantageous to allow for greater flexibility, reduced Cross Link Interference (CLI) and reduced latency. Hence, there is a need for systems and methods to partition resources among transmission and reception and MT and DU also in the frequency domain

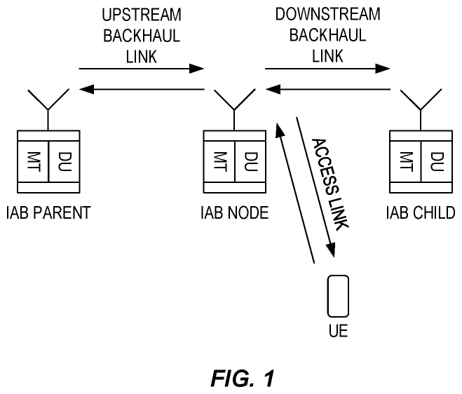

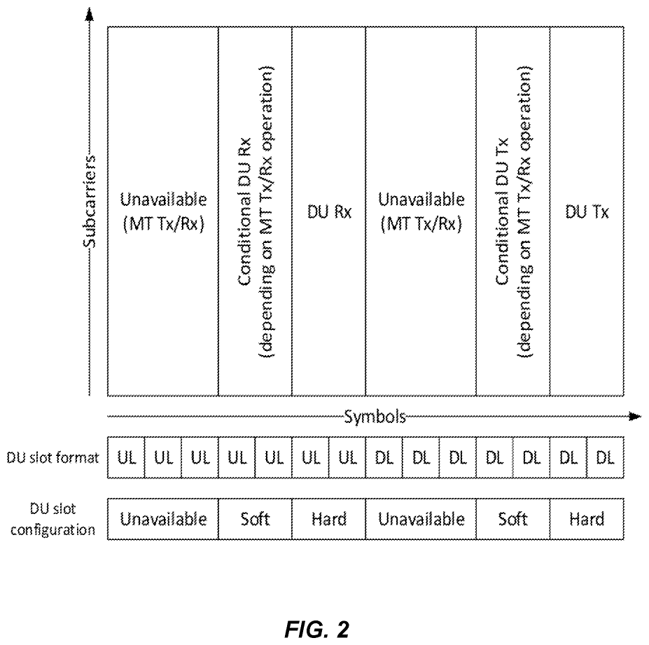

Certain aspects of the present disclosure and their embodiments may provide solutions to the aforementioned or other challenges. Embodiments of the solution(s) disclosed herein configure an IAB node, by Centralized Unit (CU) and/or other centralized or distributed functions such as, e.g., Operations and Management (OAM), with different sets of resources comprising (and possibly consisting of) frequency-domain resources, for examples, Physical Resource Blocks (PRBs). Each of the sets of resources restricts certain behavior of the IAB node in terms of transmission and/or reception. Within the constraints of the configured resource sets, the IAB node can flexibly multiplex and schedule its child links (Downstream backhaul (BH) links and access link, according to FIG. 1), e.g., depending on the node capability and real-time demands

Systems and methods are also disclosed for structuring the available spectrum to allow for DU operation in both uplink (UL) and downlink (DL) while also allowing for MT operation. As such, in one embodiment, the IAB node first receives a configuration from another network node and, thereafter, the IAB node configures its DU to operate according to said configuration. In a subsequent step, the IAB node may transmit a configuration message to child node(s), such as UE(s) or child IAB node(s) related to the configuration, and/or transmit and/or receive on the resources according to said configuration.

In a first example embodiment, a method in (the DU side of) a network IAB node for providing connectivity to a UE, where the IAB node operates in a spectrum band, is provided. The method comprises:

a. receiving a configuration message related to the spectrum band,

b. allocating a subset of subcarriers within said spectrum band according to a mode of operation, and

c. performing an operation according to the mode of operation.

In a second example embodiment, the mode of operation of the first example embodiment includes:

a. Hard, implying DU side transmission, reception or either in the subset

b. Soft, implying DU side transmission, reception or either according to a condition

c. Unavailable, implying neither transmission, nor reception

In a third example embodiment, the condition of the second embodiment depends on:

a. a subset of subcarriers on the MT side of the IAB node that are configured as unavailable or not used, and/or

b. reception, by the IAB node, of a control message that indicates a soft set of subcarriers as available for transmission or reception.

In a fourth example embodiment, the method of the second or third example embodiment is further such that the operation further depends on a symbol configuration(s) in a slot.

In a fifth example embodiment, the method of the fourth example embodiment is provided where the symbol configuration(s) is(are) one of:

a. uplink, in which case DU side will receive,

b. downlink, in which case DU side will transmit, or

c. flexible, in which case DU side will either receive or transmit.

In a sixth example embodiment, the method of the fifth example embodiment is provided such that the operation implies

a. transmitting, if the symbol is an DL symbol and the mode of operation is hard or soft and if soft, provided the condition is met,

b. receiving, if the symbol is an UL symbol and the mode of operation is hard or soft and if soft, provided the condition is met,

c. transmitting or receiving, if the symbol is a flexible symbol and the mode of operation is hard or soft and if soft, provided the condition is met, or

d. neither transmitting, nor receiving, if the mode of operation is unavailable.

In a seventh example embodiment, the operation prior to the sixth example embodiment further involves control signaling to schedule a UE and/or child IAB to transmit or receive in a certain time-frequency resource according to the configurations of the defined symbols and subset of subcarriers.

In an eighth example embodiment, preceding receiving the configuration message, the IAB node has transmitted a capability message.

In a ninth example embodiment, said capability message includes digital beamforming capability for Spatial Division Multiplexing (SDM).

In a tenth embodiment, a method in (the DU side of) a network IAB node for providing connectivity to a UE, where the IAB node operates in a spectrum band, is provided. The method comprises:

a. identifying a parent IAB node;

b. sending a capability message to the identified parent IAB node;

c. receiving one or more configuration messages related to the spectrum band from the identified parent IAB node, and

d. configuring the IAB node (e.g., the DU side of the IAB node) in accordance with the one or more configuration messages.

Certain embodiments may provide one or more of the following technical advantage(s). For example, embodiments of the present disclosure enable efficient frequency multiplexing of MT and DU operation regarding transmission and reception functionality. This introduces greater scheduling flexibility in the network and allows for reduced latency communications and improved CLI mitigation in that different IAB nodes have more degrees of freedom for scheduling.

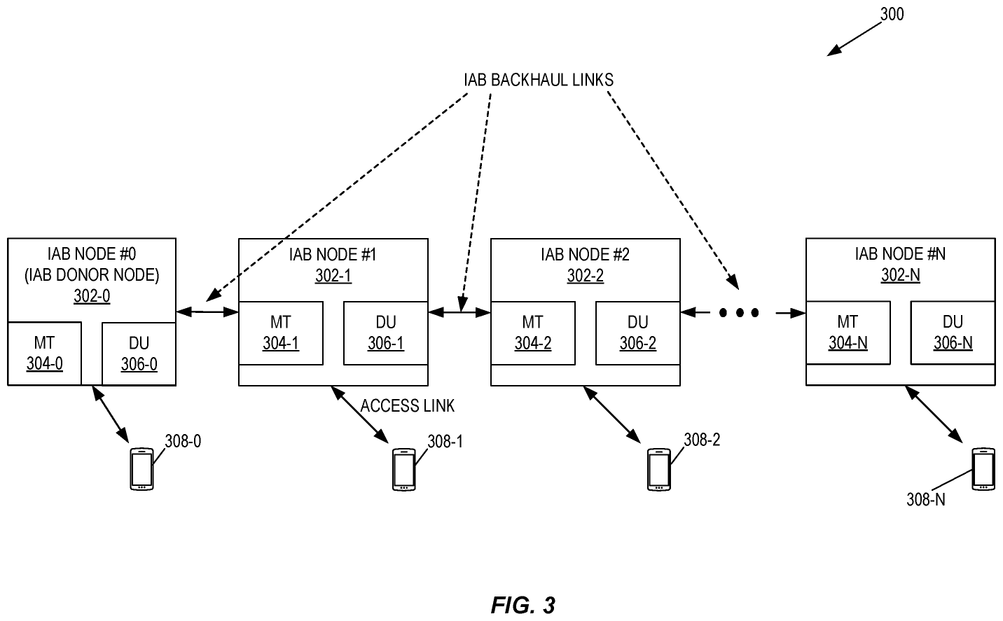

FIG. 3 illustrates one example of a radio access network (RAN) 300 in which embodiments of the present disclosure may be implemented. In the embodiments described herein, the RAN 300 is a Next Generation RAN (NG-RAN) (which is part of a 5G System (5GS) which includes the NG-RAN and a Fifth Generation Core (5GC)) or an Evolved Universal Terrestrial Radio Access Network (E-UTRAN) (which is part of an Evolved Packet System (EPS) which includes the E-UTRAN and an Evolved Packet Core (EPC)). As will be appreciated by those of skill in the art, the RAN 300 includes a number of IAB nodes 302. Specifically, in this example, the IAB nodes 302 includes an IAB donor node 302-0 and one or more additional IAB nodes, which are referred to as IAB nodes 302-1 to 302-N. The IAB nodes 302-0 through 302-N are, in some embodiments, base stations (e.g., gNBs, ng-eNBs, or eNBs). The IAB donor node 302-0 preferably has a wired backhaul connection to the core network (not shown). The IAB nodes 302-0 through 302-N include respective MTs 304-0 through 304-N and respective DUs 306-0 through 306-N. The IAB nodes 302-0 through 302-N provide radio access to respective UEs 308-0 through 308-N. Note that only one UE 308 is illustrated for each of the IAB nodes 302-0 through 302-N for clarity, it should be appreciated that each of the IAB nodes 302-0 through 302-N may provide radio access to many UEs 308. Further, a single IAB node 302 may provide backhauling to multiple child IAB nodes.

One aspect of the solution(s) described herein is a method performed by an IAB node 302-i (also referred to herein as a “network IAB node”) for providing connectivity to downlink units, e.g., UEs 308 and child IAB nodes. Here, the “IAB node 302-i” is used to refer to an i-th IAB node, where “i” is any value in the range of 0 to N. In this case, the IAB node 302-(i−1) is referred to as the “parent IAB node” of the IAB node 302-i, and the IAB node 302-(i+1) is referred to as the “child IAB node” of the IAB node 302-i. Further, this method is performed by the DU 306-i of the IAB node 302-i or in relation to the DU 306-i of the IAB node 302-i. Below, it is assumed that the IAB node 302-i is operating such that both transmission and reception on both the MT 304-i and the DU 306-i sides operate in the same spectrum or at least overlapping spectrum, but the embodiments described herein are equally valid if transmission and reception on both the MT 304-i and the DU 306-i sides is in non-overlapping spectrum.

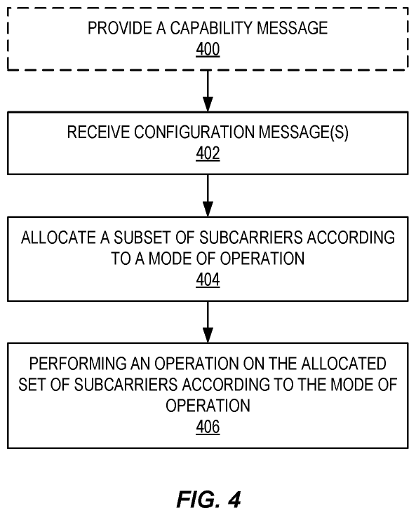

As illustrated in FIG. 4, optionally, the IAB node 302-i sends or transmits a capability message (step 400). The IAB node 302-i receives one or more configuration messages (step 402). Typically, an MT configuration originates from the CU of the DU 306 of the parent IAB node (which is also referred to herein as the “parent DU”) or from the parent DU. An IAB node's DU configuration is determined by the IAB node's CU and/or other centralized or distributed functions, such as OAM. Note that the CU may be located in the IAB donor and be used for the entire string or family of IAB nodes.

The spectrum band of the DU 306-i of the IAB node 302-i includes multiple subcarriers. In general, the configuration message(s) of step 402 includes information that divides the subcarriers into two or more subsets, each for a different mode of operation. In one embodiment, the configuration message(s) of step 402 comprise:
a DU slot configuration, which defines:
   two or more subsets of the subcarriers in the spectrum band, where these subsets of the subcarriers are also referred to herein as “subcarrier subsets”; and
   two or more modes of operation allowed for the two or more subcarrier subsets, respectively; and
in some embodiments, a DU slot format that indicates, for each of multiple symbols comprised in the slot, whether the symbol is an UL symbol, a DL symbol, or a Flexible symbol.
   In the example embodiments described herein, the DU configuration defines a first subcarrier subset for the “hard” mode of operation, a second subcarrier subset for the “soft” mode of operation, and a third subcarrier subset for the “unavailable” mode of operation. Note that the different subcarrier subsets are mutually exclusive (i.e., any single subcarrier can be in at most one subcarrier subset).

Based on the mode of operation of the IAB node 302-i, the IAB node 302-i allocates at least one of the subcarrier subsets for an operation to be performed (e.g., DU transmitting or DU receiving) (step 404). For example, if the operation is DU transmission in a particular DL symbol(s) of the slot, the IAB node 302-i allocates the subcarrier subset that is configured for the hard mode of operation and/or, if the condition for the soft mode of operation is satisfied, the subcarrier subset that is configured for the soft mode of operation. In one embodiment, if the IAB node 302-i may only use the hard part, then the scheduler of the IAB node 302-i may only schedule in the hard part whereas, if it may also use the soft part (as indicated in a control message or otherwise), it may schedule in that part too. It may never schedule in the unavailable part even though it is part of the carrier spectrum. Scheduling essentially works the same way the same for UL and DL in that it is controlled by the DU. For flexible symbols, the scheduler further gets to decide whether the symbol should be used for UL or DL transmissions. The IAB node 302-i performs the operation using the allocated subcarrier subset(s) (step 406).

In one embodiment, the modes of operation may include:

Hard, implying DU side transmission, reception, or either transmission or reception in the allocated subcarrier subset(s),

Soft, implying DU side transmission, reception, or either transmission or reception in the allocated subcarrier subset(s) subject to on a condition, and

Unavailable, implying DU side neither transmits nor receives in the subset of subcarriers.

Transmission, reception, and transmission or reception correspond to DU operations performed in Downlink, Uplink, and Flexible symbols, respectively.

In a related embodiment, the condition for the soft mode of operation may depend on, e.g.,
whether the subcarrier subset configured for the soft mode are not used or are configured as unavailable for the parent DU (i.e., at the MT side of the IAB node 302-i), and/or
whether the IAB node 302-i has received a control message that indicates the soft set of subcarriers (i.e., the subcarrier subset configured for the soft mode of operation) as available for either transmission or reception or both transmission and reception; and/or
a MT operation is not impacted; a transmission or reception by the MT is not changed by or due to a DU operation. For example, a MT is not impacted because the effect of a DU transmission in the MT operation is zero (because of multiplexing capabilities, such as full duplex). Or, a subset of subcarriers of the MT is not used because the parent DU simply does not schedule the MT (scheduling decision); alternatively, the parent DU's resources are configured Unavailable (in which case the parent DU is not allowed to use them).

The MT will be scheduled by the DU of its IAB parent node. Presumably, the CU has arranged it such that they can both operate without interfering with each other (or at least only interfere at an acceptable level).

In one embodiment, the DU slot format further restricts the operation on the symbols in the slot. The slot format may differ in several ways between the MT 304-i and the DU 306-i sides of the IAB node 302-i, depending on the capabilities of the IAB node 302-i. For example, if the IAB node 302-i is capable of multibeam reception and multibeam transmission, the IAB node 302-i may “invert” (i.e. exchange transmission and reception operation) its slot configurations on the MT 304-i and the DU 306-i sides, respectively, such that an MT DL configuration coincides with a parent DU UL configuration, allowing the IAB node 302-i to utilize its capability of receiving both from a parent IAB node on the MT 304-i side and from a UE 308-i or child IAB node on the DU 306-i side. The corresponding inversion may take place for a transmission case, in which case the MT 304-i is in UL mode and DU is DL mode. If the capabilities of the IAB node 302-i allows it, both the MT 304-i and the DU 306-i may, at least partly, be configured with the same slot configuration. Hence, a DU DL (Tx) symbol will coincide with a MT DL (Rx) symbol, implying an IAB full duplex capability of simultaneous transmission and reception.

In one embodiment, the operation that is performed in step 406 may include:

Transmitting, if the symbol is a DL symbol and the mode of operation is hard or soft, and if soft provided at least one of the conditions for utilizing the soft subset of subcarriers are met.

Receiving, if the symbol is a UL symbol and the mode of operation is hard or soft, and if soft provided at least one of the conditions for utilizing the soft subset of subcarriers are met.

Transmitting or receiving, if the symbol is a flexible symbol and the mode of operation is hard or soft, and if soft provided at least one of the conditions for utilizing the soft subset of subcarriers are met.

Neither transmitting nor receiving, if the mode of operation is unavailable.

In a related embodiment, prior to performing the operation in step 406, the DU 306-i transmits a control message to a UE 308-i or a child IAB node to receive or transmit in a specific time-frequency resource related to the DU slot format and the DU slot configuration. Resource scheduling is controlled by an IAB DU scheduler of the IAB node 302-i, which will allocate resources based on the DU resource configuration.

An example configuration of one embodiment of the present disclosure is presented in FIG. 5. FIG. 5 shows an example of frequency multiplexed DU slot configuration (hard, soft, or unavailable) in relation to a given DU slot format (uplink, downlink or flexible). In the example configuration, a DU slot format of 4 UL symbols, 5 flexible symbols and 5 DL symbols has been configured. Furthermore, the upper ⅓ of the spectrum is configured as hard, the middle ⅓ as soft, and the lower ⅓ is unavailable. The operation in the MT 304-i and the DU 306-i sides of the IAB node 302-i is presented for the resulting time-frequency resources. This configuration assumes that the IAB node 302-i is capable of simultaneous transmission and/or simultaneous reception at different frequencies, and possibly also simultaneous transmission and/or reception in different subcarrier sets (depending on MT slot format).

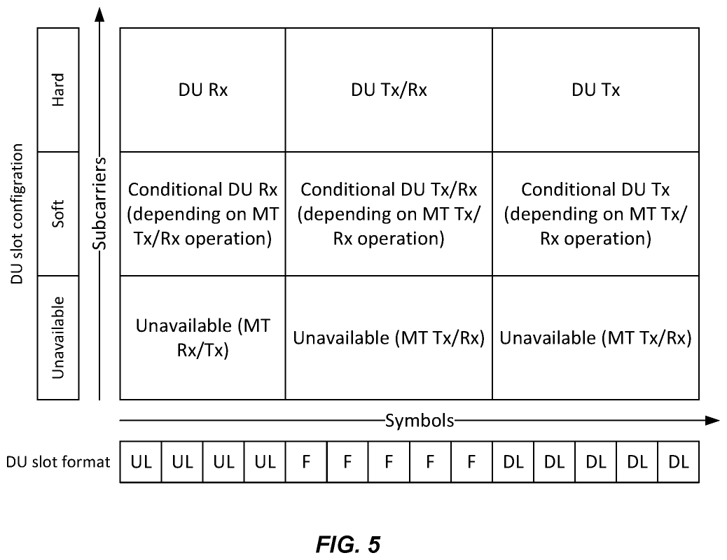

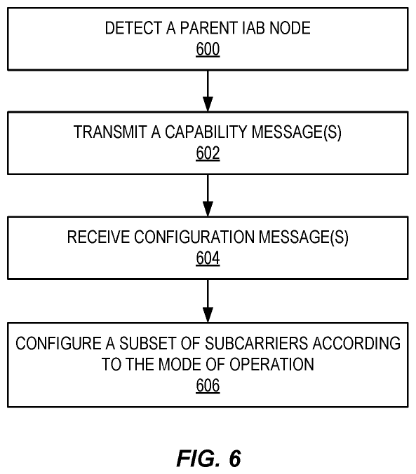

Another aspect of the solution(s) described herein is a resource configuration aspect. In this regard, FIG. 6 is a flow chart that illustrates the operation of an IAB node 302-i in accordance with another embodiment of the present disclosure. Here, the IAB node 302-i starts out by identifying a parent IAB node (step 600), e.g., by detecting a Synchronization Signal Block (SSB) from the parent IAB node or by reading information from a file or similar. As a response to detecting the parent IAB node, the IAB node 302-i transmits a capability message (step 602). The capability message includes information that indicates that the IAB node 302-i has a capability to partition spectrum according to the modes of operation, or a capability implying the partitioning of spectrum according to the modes of operation. The IAB node 302-i then receive a configuration message(s) in return (step 604). The received configuration message(s) divide the spectrum band of the IAB node 302-i into the different modes of operation, i.e., hard, soft, and unavailable, as described above. For example, subcarriers in the spectrum band may be divided into different subcarrier subsets for the different modes of operation, as described above. Finally, the IAB node 302-i configures its subcarriers according to the received configuration message(s) (step 606). This may include general configurations such as SSB transmit frequency and/or more specific scheduling configuration.

In one embodiment, the capability message of step 602 informs the parent IAB node about the capabilities of the IAB node 302-i in terms of parallel transmissions and/or reception of multiple beams or “full duplex” capability of simultaneous transmission and reception of beams. Alternatively, the capability message of step 602 provides information about simultaneous MT and DU operations (e.g., information that indicates whether or not the IAB node 302-i has the capability to perform simultaneous MT and DU operations), like the below:
simultaneous MT-TX/DU-TX,
simultaneous MT-TX/DU-RX,
simultaneous MT-RX/DU-TX, and/or
simultaneous MT-RX/DU-RX.
   In return, the IAB node 302-i receives a configuration message(s) in step 604 regarding under which circumstances simultaneous MT and DU operations are allowed according to the IAB node capabilities.

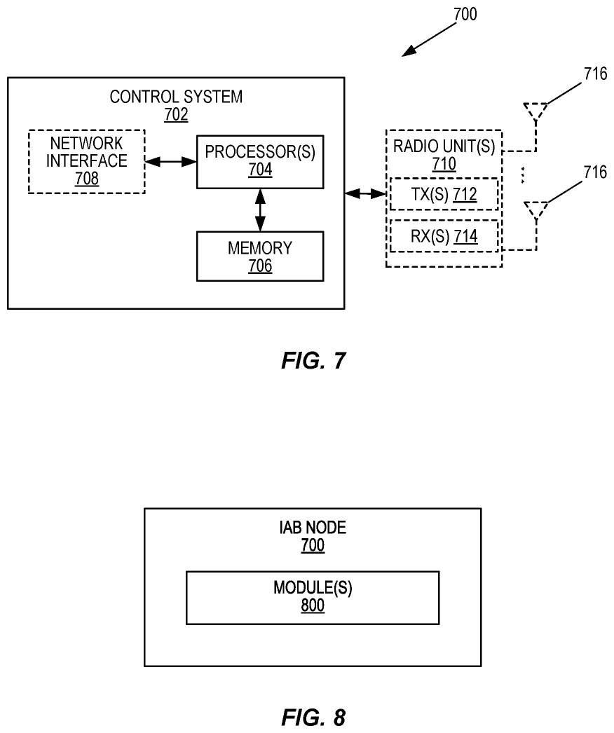

FIG. 7 is a schematic block diagram of an IAB node 700 according to some embodiments of the present disclosure. Optional features are represented by dashed boxes. The IAB node 700 may be, for example, one of the IAB nodes 302-0 through 302-N described herein. As illustrated, the IAB node 700 includes a control system 702 that includes one or more processors 704 (e.g., Central Processing Units (CPUs), Application Specific Integrated Circuits (ASICs), Field Programmable Gate Arrays (FPGAs), and/or the like), memory 706, and optionally a network interface 708. The one or more processors 704 are also referred to herein as processing circuitry. In addition, the IAB node 700 includes one or more radio units 710 that each includes one or more transmitters 712 and one or more receivers 714 coupled to one or more antennas 716. The radio units 710 may be referred to or be part of radio interface circuitry. In some embodiments, the radio unit(s) 710 is external to the control system 702 and connected to the control system 702 via, e.g., a wired connection (e.g., an optical cable). However, in some other embodiments, the radio unit(s) 710 and potentially the antenna(s) 716 are integrated together with the control system 702. The one or more processors 704 operate to provide one or more functions of the IAB node 700 as described herein (e.g., one or more functions of an IAB node, such as the IAB node 302-i, described above, e.g., with respect to FIGS. 4, 5, and/or 6). In some embodiments, the function(s) are implemented in software that is stored, e.g., in the memory 706 and executed by the one or more processors 704.

FIG. 8 is a schematic block diagram of the IAB node 700 according to some other embodiments of the present disclosure. The IAB node 700 includes one or more modules 800, each of which is implemented in software. The module(s) 800 provide the functionality of the IAB node 700 described herein (e.g., one or more functions of an IAB node, such as the IAB node 302-i, described above, e.g., with respect to FIGS. 4, 5, and/or 6).

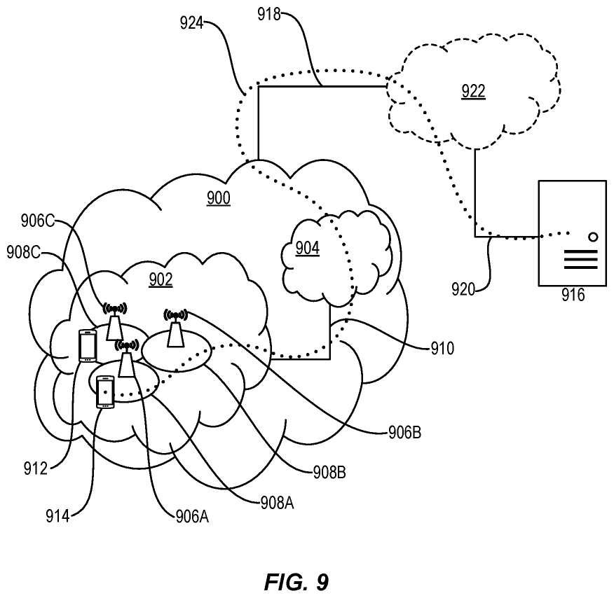

With reference to FIG. 9, in accordance with an embodiment, a communication system includes a telecommunication network 900, such as a 3GPP-type cellular network, which comprises an access network 902, such as a RAN, and a core network 904. The access network 902 comprises a plurality of base stations 906A, 906B, 906C, such as Node Bs, eNBs, gNBs, or other types of wireless Access Points (APs), each defining a corresponding coverage area 908A, 908B, 908C. Each base station 906A, 906B, 906C is connectable to the core network 904 over a wired or wireless connection 910. A first UE 912 located in coverage area 908C is configured to wirelessly connect to, or be paged by, the corresponding base station 906C. A second UE 914 in coverage area 908A is wirelessly connectable to the corresponding base station 906A. While a plurality of UEs 912, 914 are illustrated in this example, the disclosed embodiments are equally applicable to a situation where a sole UE is in the coverage area or where a sole UE is connecting to the corresponding base station 906.

The telecommunication network 900 is itself connected to a host computer 916, which may be embodied in the hardware and/or software of a standalone server, a cloud-implemented server, a distributed server, or as processing resources in a server farm. The host computer 916 may be under the ownership or control of a service provider, or may be operated by the service provider or on behalf of the service provider. Connections 918 and 920 between the telecommunication network 900 and the host computer 916 may extend directly from the core network 904 to the host computer 916 or may go via an optional intermediate network 922. The intermediate network 922 may be one of, or a combination of more than one of, a public, private, or hosted network; the intermediate network 922, if any, may be a backbone network or the Internet; in particular, the intermediate network 922 may comprise two or more sub-networks (not shown).

The communication system of FIG. 9 as a whole enables connectivity between the connected UEs 912, 914 and the host computer 916. The connectivity may be described as an Over-the-Top (OTT) connection 924. The host computer 916 and the connected UEs 912, 914 are configured to communicate data and/or signaling via the OTT connection 924, using the access network 902, the core network 904, any intermediate network 922, and possible further infrastructure (not shown) as intermediaries. The OTT connection 924 may be transparent in the sense that the participating communication devices through which the OTT connection 924 passes are unaware of routing of uplink and downlink communications. For example, the base station 906 may not or need not be informed about the past routing of an incoming downlink communication with data originating from the host computer 916 to be forwarded (e.g., handed over) to a connected UE 912. Similarly, the base station 906 need not be aware of the future routing of an outgoing uplink communication originating from the UE 912 towards the host computer 916.

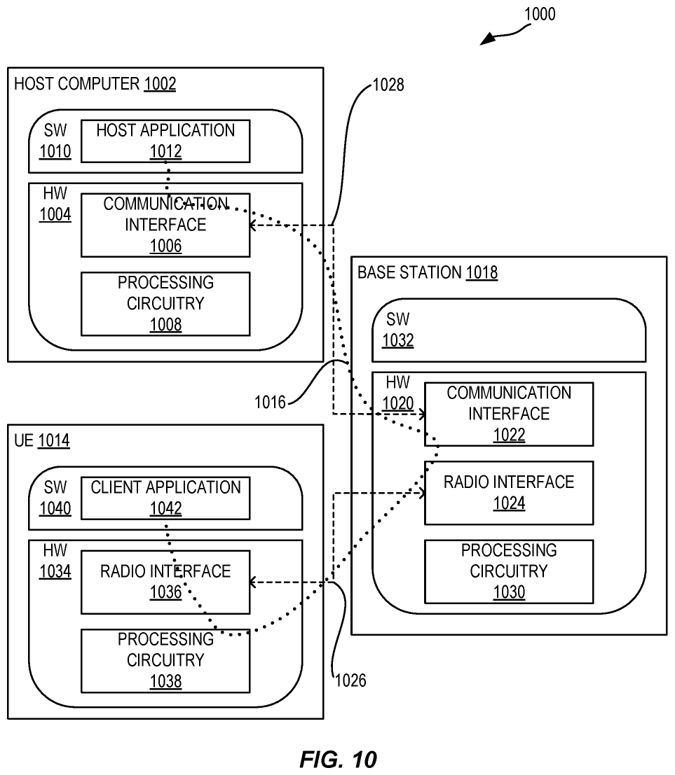

Example implementations, in accordance with an embodiment, of the UE, base station, and host computer discussed in the preceding paragraphs will now be described with reference to FIG. 10. In a communication system 1000, a host computer 1002 comprises hardware 1004 including a communication interface 1006 configured to set up and maintain a wired or wireless connection with an interface of a different communication device of the communication system 1000. The host computer 1002 further comprises processing circuitry 1008, which may have storage and/or processing capabilities. In particular, the processing circuitry 1008 may comprise one or more programmable processors, ASICs, FPGAs, or combinations of these (not shown) adapted to execute instructions. The host computer 1002 further comprises software 1010, which is stored in or accessible by the host computer 1002 and executable by the processing circuitry 1008. The software 1010 includes a host application 1012. The host application 1012 may be operable to provide a service to a remote user, such as a UE 1014 connecting via an OTT connection 1016 terminating at the UE 1014 and the host computer 1002. In providing the service to the remote user, the host application 1012 may provide user data which is transmitted using the OTT connection 1016.

The communication system 1000 further includes a base station 1018 provided in a telecommunication system and comprising hardware 1020 enabling it to communicate with the host computer 1002 and with the UE 1014. The hardware 1020 may include a communication interface 1022 for setting up and maintaining a wired or wireless connection with an interface of a different communication device of the communication system 1000, as well as a radio interface 1024 for setting up and maintaining at least a wireless connection 1026 with the UE 1014 located in a coverage area (not shown in FIG. 10) served by the base station 1018. The communication interface 1022 may be configured to facilitate a connection 1028 to the host computer 1002. The connection 1028 may be direct or it may pass through a core network (not shown in FIG. 10) of the telecommunication system and/or through one or more intermediate networks outside the telecommunication system. In the embodiment shown, the hardware 1020 of the base station 1018 further includes processing circuitry 1030, which may comprise one or more programmable processors, ASICs, FPGAs, or combinations of these (not shown) adapted to execute instructions. The base station 1018 further has software 1032 stored internally or accessible via an external connection.

The communication system 1000 further includes the UE 1014 already referred to. The UE's 1014 hardware 1034 may include a radio interface 1036 configured to set up and maintain a wireless connection 1026 with a base station serving a coverage area in which the UE 1014 is currently located. The hardware 1034 of the UE 1014 further includes processing circuitry 1038, which may comprise one or more programmable processors, ASICs, FPGAs, or combinations of these (not shown) adapted to execute instructions. The UE 1014 further comprises software 1040, which is stored in or accessible by the UE 1014 and executable by the processing circuitry 1038. The software 1040 includes a client application 1042. The client application 1042 may be operable to provide a service to a human or non-human user via the UE 1014, with the support of the host computer 1002. In the host computer 1002, the executing host application 1012 may communicate with the executing client application 1042 via the OTT connection 1016 terminating at the UE 1014 and the host computer 1002. In providing the service to the user, the client application 1042 may receive request data from the host application 1012 and provide user data in response to the request data. The OTT connection 1016 may transfer both the request data and the user data. The client application 1042 may interact with the user to generate the user data that it provides.

It is noted that the host computer 1002, the base station 1018, and the UE 1014 illustrated in FIG. 10 may be similar or identical to the host computer 916, one of the base stations 906A, 906B, 906C, and one of the UEs 912, 914 of FIG. 9, respectively. This is to say, the inner workings of these entities may be as shown in FIG. 10 and independently, the surrounding network topology may be that of FIG. 9.

In FIG. 10, the OTT connection 1016 has been drawn abstractly to illustrate the communication between the host computer 1002 and the UE 1014 via the base station 1018 without explicit reference to any intermediary devices and the precise routing of messages via these devices. The network infrastructure may determine the routing, which may be configured to hide from the UE 1014 or from the service provider operating the host computer 1002, or both. While the OTT connection 1016 is active, the network infrastructure may further take decisions by which it dynamically changes the routing (e.g., on the basis of load balancing consideration or reconfiguration of the network).

The wireless connection 1026 between the UE 1014 and the base station 1018 is in accordance with the teachings of the embodiments described throughout this disclosure. One or more of the various embodiments improve the performance of OTT services provided to the UE 1014 using the OTT connection 1016, in which the wireless connection 1026 forms the last segment. More precisely, the teachings of these embodiments may improve, e.g., latency and thereby provide benefits such as, e.g., reduced user waiting time and better responsiveness.

A measurement procedure may be provided for the purpose of monitoring data rate, latency, and other factors on which the one or more embodiments improve. There may further be an optional network functionality for reconfiguring the OTT connection 1016 between the host computer 1002 and the UE 1014, in response to variations in the measurement results. The measurement procedure and/or the network functionality for reconfiguring the OTT connection 1016 may be implemented in the software 1010 and the hardware 1004 of the host computer 1002 or in the software 1040 and the hardware 1034 of the UE 1014, or both. In some embodiments, sensors (not shown) may be deployed in or in association with communication devices through which the OTT connection 1016 passes; the sensors may participate in the measurement procedure by supplying values of the monitored quantities exemplified above, or supplying values of other physical quantities from which the software 1010, 1040 may compute or estimate the monitored quantities. The reconfiguring of the OTT connection 1016 may include message format, retransmission settings, preferred routing, etc.; the reconfiguring need not affect the base station 1018, and it may be unknown or imperceptible to the base station 1018. Such procedures and functionalities may be known and practiced in the art. In certain embodiments, measurements may involve proprietary UE signaling facilitating the host computer 1002's measurements of throughput, propagation times, latency, and the like. The measurements may be implemented in that the software 1010 and 1040 causes messages to be transmitted, in particular empty or ‘dummy’ messages, using the OTT connection 1016 while it monitors propagation times, errors, etc.

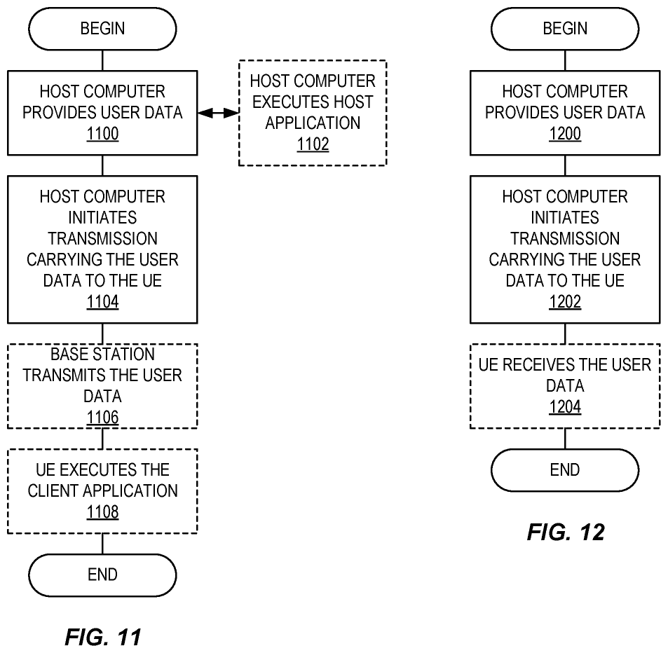

FIG. 11 is a flowchart illustrating a method implemented in a communication system, in accordance with one embodiment. The communication system includes a host computer, a base station, and a UE which may be those described with reference to FIGS. 9 and 10. For simplicity of the present disclosure, only drawing references to FIG. 11 will be included in this section. In step 1100, the host computer provides user data. In sub-step 1102 (which may be optional) of step 1100, the host computer provides the user data by executing a host application. In step 1104, the host computer initiates a transmission carrying the user data to the UE. In step 1106 (which may be optional), the base station transmits to the UE the user data which was carried in the transmission that the host computer initiated, in accordance with the teachings of the embodiments described throughout this disclosure. In step 1108 (which may also be optional), the UE executes a client application associated with the host application executed by the host computer.

FIG. 12 is a flowchart illustrating a method implemented in a communication system, in accordance with one embodiment. The communication system includes a host computer, a base station, and a UE which may be those described with reference to FIGS. 9 and 10. For simplicity of the present disclosure, only drawing references to FIG. 12 will be included in this section. In step 1200 of the method, the host computer provides user data. In an optional sub-step (not shown) the host computer provides the user data by executing a host application. In step 1202, the host computer initiates a transmission carrying the user data to the UE. The transmission may pass via the base station, in accordance with the teachings of the embodiments described throughout this disclosure. In step 1204 (which may be optional), the UE receives the user data carried in the transmission.

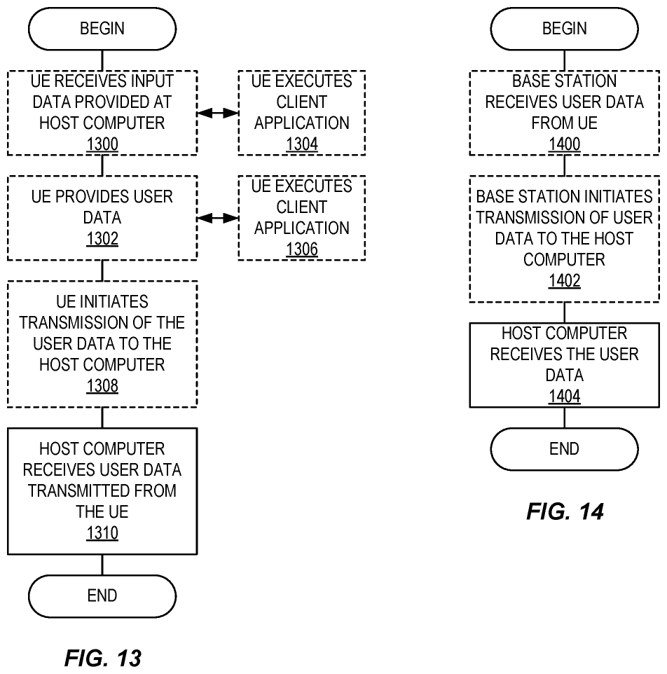

FIG. 13 is a flowchart illustrating a method implemented in a communication system, in accordance with one embodiment. The communication system includes a host computer, a base station, and a UE which may be those described with reference to FIGS. 9 and 10. For simplicity of the present disclosure, only drawing references to FIG. 13 will be included in this section. In step 1300 (which may be optional), the UE receives input data provided by the host computer. Additionally or alternatively, in step 1302, the UE provides user data. In sub-step 1304 (which may be optional) of step 1300, the UE provides the user data by executing a client application. In sub-step 1306 (which may be optional) of step 1302, the UE executes a client application which provides the user data in reaction to the received input data provided by the host computer. In providing the user data, the executed client application may further consider user input received from the user. Regardless of the specific manner in which the user data was provided, the UE initiates, in sub-step 1308 (which may be optional), transmission of the user data to the host computer. In step 1310 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station, and a UE which may be those described with reference to FIGS. 9 and 10. For simplicity of the present disclosure, only drawing references to FIG. 14 will be included in this section. In step 1400 (which may be optional), in accordance with the teachings of the embodiments described throughout this disclosure, the base station receives user data from the UE. In step 1402 (which may be optional), the base station initiates transmission of the received user data to the host computer. In step 1404 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by an IAB node (302-i) operating in a spectrum band, the method comprising: receiving (402) a configuration message(s) related to the spectrum band, the configuration message(s) comprising information that defines two or more subsets of a plurality of subcarriers within the spectrum band of the IAB node (302-i) for two or more modes of operation of a DU (306-i) of the IAB node (302-i), respectively; based on a mode of operation of the IAB node (302-i) and the information comprised in the configuration message(s), allocating (404) at least one of the two or more subsets of the plurality of subcarriers within the spectrum band for performing an operation; and performing (406) the operation on the allocated at least one of the two or more subsets of the plurality of subcarriers.

Embodiment 2: The method of embodiment 1, wherein the two or more modes of operation comprise two or more of the following modes of operation: a first mode of operation in which DU transmission, DU reception, or either DU transmission or DU reception may be performed by the IAB node (302-i); a second mode of operation in which DU transmission, DU reception, or either DU transmission or DU reception may be performed by the IAB node (302-i), subject to a condition; a third mode of operation in which neither DU transmission nor DU reception may be performed by the IAB node (302-i).

Embodiment 3: The method of embodiment 2, wherein the two or more modes of operation comprise the second mode of operation, and the condition depends on: whether the subset of the subcarriers configured for the second mode of operation are configured as unavailable not used on a MT side of the IAB node (302-i); and/or whether the IAB node (302-i) has received a control message that indicates that the subset of the subcarriers configured for the second mode of operation as available for transmission or reception.

Embodiment 4: The method of embodiment 2 or 3, where the operation depends on a symbol configuration of symbol in which the operation is to be performed within in a slot.

Embodiment 5: The method of embodiment 4, wherein the symbol configuration is one of: a configuration of the symbol as an uplink symbol in which case the operation is reception by the DU (306-i) of the IAB node (302-i), a configuration of the symbol as a downlink symbol in which case the operation is transmission by the DU (306-i) of the IAB node (302-i), or a configuration of the symbol as a flexible symbol in which case the operation is reception or transmission by the DU (306-i) of the IAB node (302-i).

Embodiment 6: The method of embodiment 5, wherein the operation is: transmitting by the DU (306-i) of the IAB node (302-i), if the symbol is a downlink symbol and the mode of operation is either: (a) the first mode of operation or (b) the second mode of operation provided the condition is met; receiving by the DU (306-i) of the IAB node (302-i), if the symbol is an uplink symbol and the mode of operation is either: (a) the first mode of operation or (b) the second mode of operation provided the condition is met; transmitting or receiving by the DU (306-i) of the IAB node (302-i), if the symbol is a flexible symbol and the mode of operation is either: (a) the first mode of operation or (b) the second mode of operation provided the condition is met; or neither transmitting nor receiving by the DU (306-i) of the IAB node (302-i), if the mode of operation is the third mode of operation.

Embodiment 7: The method of embodiment 6, wherein the operation further involves control signaling to schedule a UE and/or child IAB node to transmit or receive in a certain time-frequency resource according to the configurations of the defined symbol(s) and the allocated at least one of the two or more subsets of the plurality of subcarriers.

Embodiment 8: The method of any of embodiments 1 to 7, further comprising, prior to receiving the one or more configuration messages, transmitting (400) a capability message (e.g., to a parent IAB node).

Embodiment 9: The method of embodiment 8, wherein the capability message comprises information that indicates that the IAB node (302-i) has digital beamforming capability for SDM.

Embodiment 10: The method of any of the previous embodiments, further comprising: obtaining user data; and forwarding the user data to a host computer or a wireless device.

### Group B Embodiments

Embodiment 11: An IAB node (302-i) comprising: processing circuitry configured to perform any of the steps of any of the Group A embodiments; and power supply circuitry configured to supply power to the IAB node.

Embodiment 12: A communication system including a host computer comprising: processing circuitry configured to provide user data; and a communication interface configured to forward the user data to a cellular network for transmission to a User Equipment, UE; wherein the cellular network comprises an IAB node having a radio interface and processing circuitry, the IAB node's processing circuitry configured to perform any of the steps of any of the Group A embodiments.

Embodiment 13: The communication system of the previous embodiment further including the IAB node.

Embodiment 14: The communication system of the previous 2 embodiments, further including the UE, wherein the UE is configured to communicate with the IAB node.

Embodiment 15: The communication system of the previous 3 embodiments, wherein: the processing circuitry of the host computer is configured to execute a host application, thereby providing the user data; and the UE comprises processing circuitry configured to execute a client application associated with the host application.

Embodiment 16: A method implemented in a communication system including a host computer, an IAB node, and a User Equipment, UE, the method comprising: at the host computer, providing user data; and at the host computer, initiating a transmission carrying the user data to the UE via a cellular network comprising the IAB node, wherein the IAB node performs any of the steps of any of the Group A embodiments.

Embodiment 17: The method of the previous embodiment, further comprising, at the IAB node, transmitting the user data.

Embodiment 18: The method of the previous 2 embodiments, wherein the user data is provided at the host computer by executing a host application, the method further comprising, at the UE, executing a client application associated with the host application.

Embodiment 19: A User Equipment, UE, configured to communicate with an IAB node, the UE comprising a radio interface and processing circuitry configured to perform the method of the previous 3 embodiments.

Embodiment 20: A communication system including a host computer comprising a communication interface configured to receive user data originating from a transmission from a User Equipment, UE, to an IAB node, wherein the IAB node comprises a radio interface and processing circuitry, the IAB node's processing circuitry configured to perform any of the steps of any of the Group A embodiments.

Embodiment 21: The communication system of the previous embodiment further including the IAB node.

Embodiment 22: The communication system of the previous 2 embodiments, further including the UE, wherein the UE is configured to communicate with the IAB node.

Embodiment 23: The communication system of the previous 3 embodiments, wherein: the processing circuitry of the host computer is configured to execute a host application; and the UE is configured to execute a client application associated with the host application, thereby providing the user data to be received by the host computer.

Those skilled in the art will recognize improvements and modifications to the embodiments of the present disclosure. All such improvements and modifications are considered within the scope of the concepts disclosed herein.

1. A method performed by an Integrated Access and Backhaul node configured to operate in a spectrum band, the method comprising:
receiving one or more configuration messages related to the spectrum band, the one or more configuration messages comprising information that defines two or more modes of operation of a distributed unit of the IAB node that are allowed for two or more subsets of a plurality of subcarriers within the spectrum band of the IAB node, respectively;
based on a mode of operation of the IAB node and the information comprised in the configuration message(s), allocating at least one of the two or more subsets of the plurality of subcarriers within the spectrum band for performing an operation; and
performing the operation on the allocated at least one of the two or more subsets of the plurality of subcarriers.

2. The method of claim 1, wherein the two or more subsets of the plurality of subcarriers within the spectrum band of the IAB node are mutually exclusive.

3. The method of claim 1, wherein the two or more modes of operation comprise two or more of the following modes of operation:
a first mode of operation in which DU transmission, DU reception, or either DU transmission or DU reception may be performed by the IAB node;
a second mode of operation in which DU transmission, DU reception, or either DU transmission or DU reception may be performed by the IAB node, subject to a condition;
a third mode of operation in which neither DU transmission nor DU reception may be performed by the IAB node.

4. The method of claim 3, wherein the two or more modes of operation comprise the second mode of operation, and the condition depends on:
(a) whether the subset of the subcarriers configured for the second mode of operation are configured as unavailable for the DU of a parent IAB node or not used on a mobile termination, MT, side of the IAB node;
(b) whether the IAB node has received a control message that indicates that the subset of the subcarriers configured for the second mode of operation are available for transmission or reception;
(c) whether operation on the MT side of the IAB is not impacted; or
(d) a combination of two or more of (a)-(c).

5. The method of claim 3, where the operation performed by the IAB node depends on a symbol configuration of symbol in which the operation is to be performed within in a slot.

6. The method of claim 5, wherein the symbol configuration is one of:
a configuration of the symbol as an uplink symbol in which case the operation is reception by the DU of the IAB node,
a configuration of the symbol as a downlink symbol in which case the operation is transmission by the DU of the IAB node, or
a configuration of the symbol as a flexible symbol in which case the operation is reception or transmission by the DU of the IAB node.

7. The method of claim 6, wherein the operation performed by the IAB node is:
transmitting by the DU of the IAB node, if the symbol in which the operation is to be performed is a downlink symbol and the mode of operation is either: (a) the first mode of operation or (b) the second mode of operation provided the condition is met;
receiving by the DU of the IAB node, if the symbol in which the operation is to be performed is an uplink symbol and the mode of operation is either: (a) the first mode of operation or (b) the second mode of operation provided the condition is met;
transmitting or receiving by the DU of the IAB node, if the symbol in which the operation is to be performed is a flexible symbol and the mode of operation is either: (a) the first mode of operation or (b) the second mode of operation provided the condition is met; or
neither transmitting nor receiving by the DU of the IAB node, if the mode of operation is the third mode of operation.

8. The method of claim 7, wherein the operation performed by the IAB node further involves control signaling to schedule a User Equipment and/or a child IAB node to transmit or receive in a certain time-frequency resource according to the configurations of a symbol(s) in which the operation is to be performed by the IAB node and the allocated at least one of the two or more subsets of the plurality of subcarriers.

9. The method of claim 1, further comprising, prior to receiving the one or more configuration messages, transmitting a capability message to a parent IAB node.

10. The method of claim 9, wherein the capability message comprises information that indicates that the IAB node has digital beamforming capability for Spatial Division Multiplexing (SDM).

11. The method of claim 9, wherein the capability message comprises information that indicates that the IAB node has a capability to partition the frequency spectrum according to the two or more modes of operation.

12-13. (canceled)

14. An Integrated Access and Backhaul node configured to operate in a spectrum band, the IAB node comprising a radio unit and processing circuitry configured to cause the IAB node to:
receive one or more configuration messages related to the spectrum band, the one or more configuration messages comprising information that defines two or more modes of operation of a distributed unit of the IAB node that are allowed for two or more subsets of a plurality of subcarriers within the spectrum band of the IAB node, respectively;
based on a mode of operation of the IAB node and the information comprised in the configuration message(s), allocate at least one of the two or more subsets of the plurality of subcarriers within the spectrum band for performing an operation; and
perform the operation on the allocated at least one of the two or more subsets of the plurality of subcarriers.

15-17. (canceled)

18. The IAB node of claim 14, wherein the two or more modes of operation comprise two or more of the following modes of operation:
a first mode of operation in which DU transmission, DU reception, or either DU transmission or DU reception may be performed by the IAB node;
a second mode of operation in which DU transmission, DU reception, or either DU transmission or DU reception may be performed by the IAB node, subject to a condition;
a third mode of operation in which neither DU transmission nor DU reception may be performed by the IAB node.

19. The IAB node of claim 18, wherein the two or more modes of operation comprise the second mode of operation, and the condition depends on:
(a) whether the subset of the subcarriers configured for the second mode of operation are configured as unavailable for the DU of a parent IAB node or not used on a mobile termination, MT, side of the IAB node;
(b) whether the IAB node has received a control message that indicates that the subset of the subcarriers configured for the second mode of operation are available for transmission or reception;
(c) whether operation on the MT side of the IAB is not impacted; or
(d) a combination of two or more of (a)-(c).

20. The IAB node of claim 14, further comprising, prior to receiving the one or more configuration messages, transmitting a capability message to a parent IAB node.

21. The IAB node of claim 20, wherein the capability message comprises information that indicates that the IAB node has digital beamforming capability for Spatial Division Multiplexing (SDM).

22. The IAB node of claim 21, wherein the capability message comprises information that indicates that the IAB node has a capability to partition the frequency spectrum according to the two or more modes of operation.

23. A non-transient computer-readable storage medium, having instructions stored thereon that when executed, by processing circuitry of an Integrated Access and Backhaul (IAB) node configured to operate in a spectrum band, cause the processing circuitry to perform operations comprising:
receive one or more configuration messages related to the spectrum band, the one or more configuration messages comprising information that defines two or more modes of operation of a distributed unit (DU) of the IAB node that are allowed for two or more subsets of a plurality of subcarriers within the spectrum band of the IAB node, respectively;
based on a mode of operation of the IAB node and the information comprised in the configuration message(s), allocate at least one of the two or more subsets of the plurality of subcarriers within the spectrum band for performing an operation; and
perform the operation on the allocated at least one of the two or more subsets of the plurality of subcarriers.

24. The computer-readable storage medium of claim 23, wherein the instructions, executed, further cause the processing circuitry to perform operations comprising:
prior to receiving the one or more configuration messages, transmitting a capability message to a parent IAB node.

25. The computer-readable storage medium of claim 23, wherein the two or more modes of operation comprise a first mode of operation in which DU transmission, DU reception, or either DU transmission or DU reception may be performed by the IAB node, subject to a condition, where wherein the condition depends on:
(a) whether the subset of the subcarriers configured for the second mode of operation are configured as unavailable for the DU of a parent IAB node or not used on a mobile termination, MT, side of the IAB node;
(b) whether the IAB node has received a control message that indicates that the subset of the subcarriers configured for the second mode of operation are available for transmission or reception;
(c) whether operation on the MT side of the IAB is not impacted; or
(d) a combination of two or more of (a)-(c).
